(19) United States
(12) Patent Application Publication
(10) Pub. No.: US 2005/0164717 A1
(43) Pub. Date: Jul. 28, 2005

(54) Method for combating tracking of a mobile transceiver

(75) Inventor: Huang Leping, Saitama-ken (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/762,703

(22) Filed: Jan. 21, 2004

(51) Int. Cl. H04Q 7/20

(52) U.S. Cl. 455/458

(57) ABSTRACT

A method for combating the tracking of a mobile transceiver, comprising at the mobile transceiver: enabling, until a first time, the transmission of a radio packet that depends upon a first anonymous address; enabling, from a second time, the transmission of a radio packet that depends upon a second anonymous address; and disabling, between the first time and the second time, the transmission of a radio packet that depends upon either the first anonymous address or the second anonymous address. Also described is a method for combating the tracking of a mobile transceiver, comprising at the mobile transceiver: transmitting, until a first time, radio packets that depend upon a first anonymous address; transmitting, from a second time, radio packets that depend upon a second anonymous address; and transmitting, between the first time and the second time, radio packets that depend on neither the first anonymous address nor the second anonymous address.

### FIELD OF THE INVENTION

Embodiments of the invention relate to a method for combating tracking of a mobile transceiver.

### BACKGROUND TO THE INVENTION

According to the current Bluetooth Specification (version 1.1), the content of which is hereby incorporated by reference, Bluetooth devices, when in discoverable mode, always reply to inquiry requests with a FHS packet that identifies the unique 48-bit Bluetooth device address of the device.

If a malicious user has access to a widely deployed Bluetooth Access Pont network, he can track the positions of all Bluetooth devices by repeatedly sending inquiry requests and collecting the FHS packets sent in reply. As each FHS packet received in reply contains a device's permanent and unique Bluetooth address, the malicious user can track, from the received replies, individual devices as they move.

A malicious user may alternatively intercept (sniff) all Bluetooth packets sent over the air.

To prevent position tracking, there is a current proposal to enhance the current Bluetooth specification by including an ‘anonymity mode’. The details of this proposal are not yet public. However, in anonymity mode, a node uses a randomly generated Bluetooth address BD_ADDR (an anonymous address) instead of the permanent and unique Bluetooth address. Location tracking is combated by regularly updating the anonymous address.

According to the ‘anonymity mode’ proposal each Bluetooth device has a unique 48-bit Bluetooth device address (BD_ADDR_fixed). The address includes a lower address part (LAP) of 24 bits, an upper address part (UAP) of 8 bits and a non-significant address part of 16 bits. Each device also has a 48-bit Bluetooth active device address (BD_ADDR), which has the same format as BD_ADDR_fixed.

For non-anonymous devices or for devices that do not support anonymity mode, the BD_ADDR equals BD_ADDR_fixed and is not updated.

For devices in anonymous mode, the LAP of the BD_ADDR is pseudo-random and is updated frequently. The updating depends upon two parameters: the address update period (T_{ADDR}_{_{—}}_{update}) and the reserved period for inquiry (T_{ADDR}_{_{—}}_{inquiry period}). A timer t1 is used to trigger address updates and is re-started when a new BD_ADDR has been generated. A timer t2 is started whenever a BD_ADDR is sent in a FHS packet, such as in an inquiry response, master page response or master-slave role switch. The timer t2 prevents an address update for a critical period after sending an FHS packet.

While t1≦T_{ADDR}_{_{—}}_{update} or t2≦T_{ADDR}_{_{—}}_{inquiry period}, then the BD_ADDR is not updated. However, whenever t1>T_{ADDR}_{_{—}}_{update} and t2<T_{ADDR}_{_{—}}_{inquiry period} the process for updating BD_ADDR is started.

The value of T_{ADDR}_{_{—}}_{update} can range between 1 second and 194 days, but has a default value of 24 hours. The value of T_{ADDR}_{_{—}}_{inquiry period} can range between 30 and 255 seconds, but has a default value of 60 seconds. Thus, if the default values are used, the anonymous address is updated approximately every 24 hours.

If an updated address BD_ADDR is generated by a Master, all connected devices in the piconet that support anonymity mode are informed of the updated address BD_ADDR and of a future time at which the Master will start to use the updated address.

The BD_ADDR of a device is used to define a hopping sequence, the channel access code (CAC) and device access code (DAC) for the device. A change in the BD_ADDR changes the DAC and hopping sequence used to transmit a FHS packet in response an inquiry request. A change in the BD_ADDR of a Master changes the CAC and hopping sequence used to transmit packets within the piconet controlled by the Master.

The periodic updating of the anonymous address is intended to prevent location tracking.

However, the inventor has realized that the currently proposed anonymity mode may not necessarily prevent location tracking.

The proposal becomes inefficient at combating location tracking of a Bluetooth device when there is a low density of surrounding Bluetooth devices, when the Bluetooth device moves very slowly and when the position of the Bluetooth device can be very accurately determined.

Although the current proposal for anonymity mode may be sufficient for current Bluetooth based positioning technology that has a resolution of 1 m, the inventor has realized that as location technology improves and Bluetooth devices can be accurately located then the current proposal for ‘anonymity mode’ may not prevent Bluetooth devices being tracked. This is because, as a device can be positioned accurately it will be possible to find a strong correlation between a trail left by an old anonymous address and that left by a new anonymous address. The old and new anonymous addresses can therefore be linked. Such correlation becomes easier as the distance between Bluetooth devices increase, the speed of a device decreases and the accuracy with which a device can be positioned increases.

### BRIEF DESCRIPTION OF THE INVENTION

According to one embodiment of the invention, there is provided a method for combating the tracking of a mobile transceiver, comprising at the mobile transceiver: enabling, until a first time, the transmission of a radio packet that depends upon a first anonymous address; enabling, from a second time, the transmission of a radio packet that depends upon a second anonymous address; and disabling, between the first time and the second time, the transmission of a radio packet that depends upon either the first anonymous address or the second anonymous address.

According to another embodiment of the invention, there is provided a method for combating the tracking of a mobile transceiver, comprising at the mobile transceiver: transmitting, until a first time, radio packets that depend upon a first anonymous address; transmitting, from a second time, radio packets that depend upon a second anonymous address; and transmitting, between the first time and the second time, radio packets that depend on neither the first anonymous address nor the second anonymous address.

According to another embodiment of the invention, there is provided a method for combating the tracking of a plurality of mobile transceivers each of which has its own local time reference, comprising, at each of the plurality of mobile transceivers: enabling, until a first local time, the transmission of a radio packet that depends upon a locally generated first anonymous address; enabling, from a second local time, the transmission of a radio packet that depends upon a locally generated second anonymous address; and disabling, between the first local time and the second local time, the transmission of a radio packet that depends on either its locally generated first anonymous address or its locally generated second anonymous address.

According to another embodiment of the invention, there is provided a method for combating the tracking of a plurality of mobile transceivers that are time synchronized to a common time reference, comprising, at each of the plurality of mobile transceivers: enabling, until a first common time, the transmission of a radio packet that depends upon its first anonymous address; enabling, from a second common time, the transmission of a radio packet that depends upon its second anonymous address; and disabling, between the first common time and the second common time, the transmission of a radio packet that depends on either its first anonymous address or its second anonymous address.

Introducing a transition period between using the old and new anonymous addresses in which nether the old or new address is used obscures when and where an anonymous address change occurs. This combats the tracking of the mobile transceiver.

### BRIEF DESCRIPTION OF THE DRAWINGS

For a better understanding of the present invention and to understand how it may be brought into effect, reference will now be made by way of example only to the accompanying drawings in which:

FIG. 1 illustrates a piconet that comprises a plurality of Bluetooth-enabled radio transceiver devices;

FIG. 2A illustrates the movement of two mobiles transceiver devices 2A and 2B which do not use the invention;

FIG. 2A illustrates the movement of two mobiles transceiver devices 2A and 2B which use one embodiment of the invention; and

FIG. 3 illustrates a radio transceiver device.

### DETAILED DESCRIPTION OF EMBODIMENT(S) ON THE INVENTION

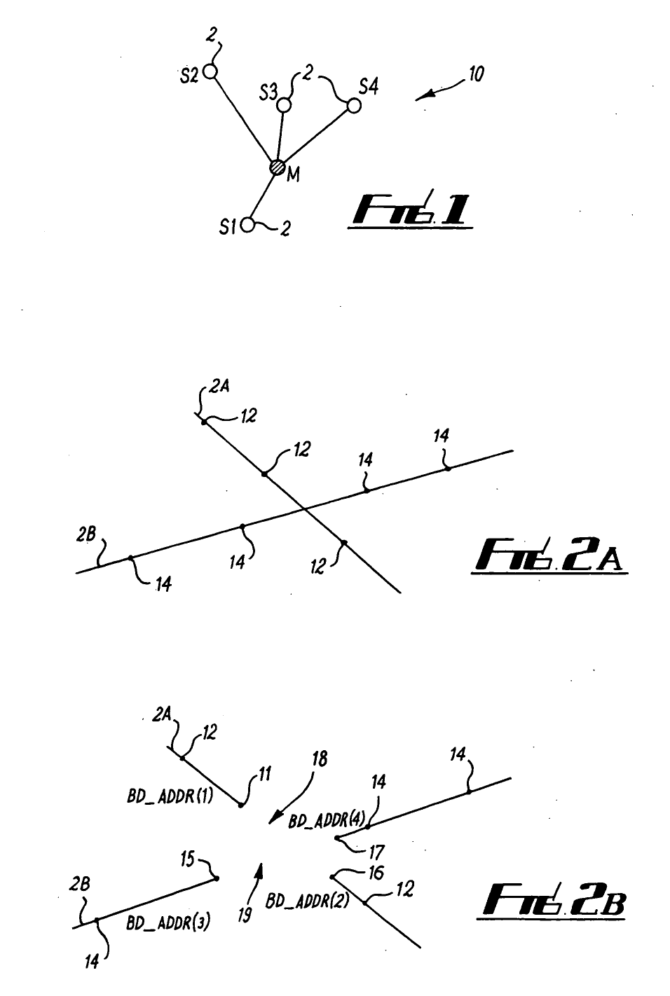

FIG. 1 illustrates a piconet 10 that comprises a plurality of Bluetooth-enabled radio transceiver devices 2. Some of the devices 2 may be mobile. Each device communicates using packets transmitted over a radio communication range of approximately 10 m.

The transceiver devices 2 of the piconet 10 comprise a Master M and a plurality of Slaves S1, S2, S3 and S4. The Master M controls the piconet 10. The timing of the piconet is based upon the timing of the Master M. The frequency-hopping sequence used by the network is based upon the BD_ADDR of the Master and the packets sent within the piconet have as their synchronization word an Access Code derived from the BD_ADDR of the Master M.

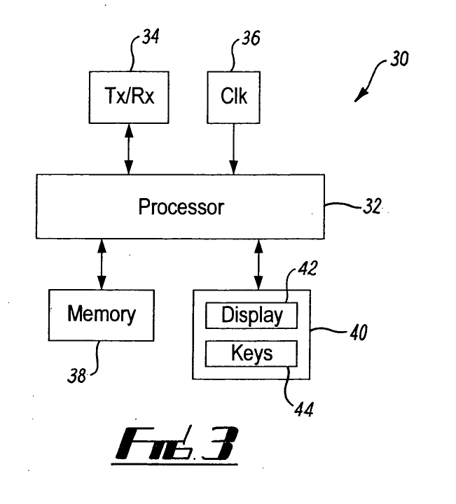

FIG. 2A illustrates the movement of two mobiles transceiver devices 2A and 2B. The transceiver device 2A changes its anonymous address at each point 12 along its path. The new address may be immediately obtained by initiating an Inquiry request or by sniffing communications by the transceiver device 2A.

The transceiver device 2B changes its anonymous address at each of the points 14 along its path. The new address may be immediately obtained by initiating an Inquiry request or by sniffing communications by the transceiver device 2A.

It may be possible to associate a first anonymous address received from a transceiver device when at position P1 with a second anonymous address previously received from a transceiver device when at position P2 with the same transceiver device because of temporal and/or spatial correlation. Temporal correlation may be used because the period with which transceiver devices change their anonymous addresses may be fixed but different. Spatial correlation may be used if it is assumed that transceiver devices will generally continue in the same direction with the same speed as they traveled in the past.

FIG. 2B illustrates the movement of two mobile transceiver devices 2A and 2B utilizing an embodiment of the present invention.

The first mobile transceiver 2A enables, until a first time 11, the transmission of a radio packet that depends upon a first anonymous address BD_ADDR(1). The first mobile transceiver 2A enables, from a second time 16, the transmission of a radio packet that depends upon a second anonymous address BD_ADDR(2). The first mobile transceiver 2A disables for a transitional silence period 18, between the first time 11 and the second time 16, the transmission of all radio packets that depend on either the first anonymous address BD_ADDR(1) or the second anonymous address BD_ADDR(2).

Although, transmissions are limited between the first time and the second time, it is still possible to transmit radio packets that do not identify the first transceiver device because they depend on neither the first anonymous address nor the second anonymous address. This will only be possible if the transceiver device is operating as a Slave.

The transceiver device 2A changes its anonymous address at each point 12 along its path. However, for the sake of clarity the effect of the invention is only illustrated near the intersection of the paths of both transceiver devices. silence period 18 is illustrated by a break in the path of the device 2A. The silence period begins at the first time 11 and ends at a second time 16.

Likewise the second mobile transceiver 2B enables, until a third time 15, the transmission of a radio packet that depends upon a third anonymous address BD_ADDR(3). The second mobile transceiver 2B enables, from a fourth time 17, the transmission of a radio packet that depends upon a fourth anonymous address BD_ADDR(4). The first mobile transceiver 2A disables for a transitional silence period 19, between the third time 15 and the fourth time 17, the transmission of all radio packets that depend on either the third anonymous address BD_ADDR(3) or the fourth anonymous address BD_ADDR(4).

Although, transmissions are limited between the third time and the fourth time, it is still possible to transmit radio packets that cannot identify the transceiver device because they depend on neither the third anonymous address nor the second anonymous address. This will only be possible if the transceiver device is operating as a Slave.

The transceiver device 2B changes its anonymous address at each point 12 along its path. However, for the sake of clarity the effect of the invention is only illustrated near the intersection of the paths of both transceiver devices. The silence period 19 is illustrated by a break in the path of the device 2B. The silence period begins at the first time 15 and ends at a second time 17.

The silent transitional periods introduce ambiguity into any determination of the time and/or place at which a change of anonymous address occurred. This makes it more difficult to associate two separately received anonymous addresses with the same transceiver device because the silence periods disrupt temporal and/or spatial correlation.

A transmission of a radio packet may depend upon an anonymous address when:
a) it includes the anonymous address
b) it includes a synchronization word based upon the anonymous address such a Common Access Code (CAC) or Device Access Code (DAC).
c) it uses a frequency from a frequency-hopping-sequence based upon the anonymous address, for example when an FHS packet is sent by a Slave.
d) it is a L2CAP link establishment packet

Thus disabling during the silent transitional period may prevent:
(i) the transmission of FHS packets between the first time and the second time
(ii) the mobile transceiver performing an inquiry scan or replying to an inquiry request between the first time and the second time
(iii) the mobile transceiver performing a page scan or replying to a page request between the first time and the second time
   Synchronized Network

The first transceiver device 2A and the second transceiver device 2B of FIG. 2B may be time synchronized to a common time reference. The first time and the third time correspond to the same first common time, and the second time and the fourth time correspond to the same second common time.

The time duration between the first common time and the second common time is adjustable. The adjustment is preferably automatic and may be dependent upon:
a) a measure of the separation of the mobile transceivers
b) a measure of the accuracy with which a mobile transceiver can be located
c) a measure of the speed with which a mobile transceiver moves

Each of these measure may be user configurable. The user may either enter a value for the measure or select a pre-defined measure.

The measure of the separation of the plurality of the mobile transceivers may be obtained automatically from one or more inquiry requests, which will identify the number of radio transceiver devices that are within communication range.

The measure of the accuracy with which a mobile transceiver can be located may be remotely configurable by, for example, a data download. It will also depend upon the technology used for location e.g. triangulation, GPS etc.

The time duration T between the first common time and the second common time, is such that T≧(d−4*e)/2v, where d is a minimum separation in meters between the transceiver device and its neighboring transceiver devices, e is the error in meters associated with the technology used for locating the transceiver device and v is the average rectilinear velocity of the transceiver device. A pedestrian typically moves with a velocity of 6 km/h, whereas a car may move with a velocity of 60 km/h.

Unsynchronized Network

The first transceiver device 2A and the second transceiver device 2B of FIG. 2B may not be time synchronized. Each transceiver device has its own local time reference. In this case the first time and the third time are independent and the second time and the fourth time are independent.

The difference between the first (local) time and the second (local) time may comprise a calculated minimum period and an independent, randomly generated period.

The minimum period is calculated in dependence upon:
a) a measure of the separation between the first mobile transceiver 2A and its neighboring mobile transceivers
b) a measure of the accuracy with which the first mobile transceiver 2A can be located
c) a measure of the speed with which the first mobile transceiver 2A moves

Each of these measures may be user configurable. The user may either enter a value for the measure or select a pre-defined measure.

The measure of the separation may be obtained automatically from one or more inquiry requests, which will identify the number of radio transceiver devices that are within communication range.

The measure of the accuracy with which a mobile transceiver can be located may be remotely configurable by, for example, a data download. It will also depend upon the technology used for location e.g. triangulation, GPS etc.

The minimum period T1, is such that T1≧(d−4*e)/2v, where d is an average separation in meters between the first transceiver device 2A and its neighboring transceiver devices, e is the error in meters associated with the technology used for locating the first transceiver device 2A and v is the average rectilinear velocity of the first transceiver device 2A.

The value of T_{ADDR}_{_{—}}_{update}, that is the frequency with which anonymous address of the first transceiver device 2A is changed, may also be automatically adjustable. The adjustment may dependent upon:
a) a measure of the separation between the first mobile transceiver 2A and its neighboring mobile transceivers
b) a measure of the accuracy with which the first mobile transceiver 2A can be located
c) a measure of the speed with which the first mobile transceiver 2A moves

Each of these measures may be user configurable. The user may either enter a value for the measure or select a pre-defined measure.

The measure of the separation may be obtained automatically from one or more inquiry requests, which will identify the number of radio transceiver devices that are within communication range.

The measure of the accuracy with which a mobile transceiver can be located may be remotely configurable by, for example, a data download. It will also depend upon the technology used for location e.g. triangulation, GPS etc.

The difference between third (local) time and the fourth (local) time also comprises a calculated minimum period and an independent, randomly generated period.

The minimum period is calculated in dependence upon:
a) a measure of the separation between the second mobile transceiver 2B and its neighboring mobile transceivers
b) a measure of the accuracy with which the second mobile transceiver 2B can be located
c) a measure of the speed with which the second mobile transceiver 2B moves

Each of these measures may be user configurable. The user may either enter a value for the measure or select a pre-defined measure.

The minimum period T1, is such that T1≧(d−4*e)/2v, where d is an average separation in meters between the second transceiver device 2B and its neighboring transceiver devices, e is the error in meters associated with the technology used for locating the second transceiver device 2B and v is the average rectilinear velocity of the second transceiver device 2B.

The value of T_{ADDR}_{_{—}}_{update}, that is the frequency with which anonymous address of the second transceiver device 2B is changed, may also be automatically adjustable. The adjustment may dependent upon:
a) a measure of the separation between the second mobile transceiver 2B and its neighboring mobile transceivers
b) a measure of the accuracy with which the second mobile transceiver 2B can be located
c) a measure of the speed with which the second mobile transceiver 2B moves

FIG. 3 illustrates an example of a typical Bluetooth enabled radio transceiver device 30. The transceiver device 30 comprises a processor 32, a radio transceiver 34, a clock 36, a memory 38 and a user interface 40, which includes a display 42 and a keypad 44 for user input. It should be appreciated that this illustration is only a schematic.

The processor 32 is connected to each of the radio transceiver 34, clock 36, memory 38 and user interface 40.

The processor uses the clock 36 to maintain a timer t, which is used to control the silent transitional period 18,19.

The memory 38 stores computer program instructions, which when loaded into the processor 32 enable it to perform the methods described above.

The transceiver device 30 may park the Slaves in the piconet if the silent transitional period will exceed the Link_Supervision timeout period i.e. the maximum period for which there can be no communication on a link without it being assumed that the link has been lost.

Although embodiments of the invention have been described in the preceding paragraphs with reference to various examples, it should be appreciated that various modification may be made thereto without departing from the spirit and scope of the invention. For example, although the invention has been described in relation to a Bluetooth low power radio frequency network, it may be used in other radio networks where it is desirable to combat the tracking of devices and/or users. Thus the invention may be applied, for example, to mobile cellular telecommunication networks.

1. A method for combating the tracking of a mobile transceiver, comprising at the mobile transceiver:
enabling, until a first time, the transmission of a radio packet that depends upon a first anonymous address;
enabling, from a second time, the transmission of a radio packet that depends upon a second anonymous address; and
disabling, between the first time and the second time, the transmission of a radio packet that depends upon either the first anonymous address or the second anonymous address.

2. A method as claimed in claim 1, further comprising: randomly generating at least a portion of the first anonymous address before enabling the transmission of a radio packet that depends upon the first anonymous address and randomly generating at least a portion of the second anonymous address before enabling the transmission of a radio packet that depends upon the second anonymous address.

3. A method as claimed in claim 1, wherein the step of disabling, comprises disabling between the first time and the second time, the transmission of all radio packets that depend on either the first anonymous address or the second anonymous address.

4. A method as claimed in claim 1, wherein a transmission of a radio packet depends upon an anonymous address when it includes the anonymous address.

5. A method as claimed in claim 1, wherein a transmission of a radio packet depends upon an anonymous address when it includes a synchronization word based upon the anonymous address.

6. A method as claimed in claim 1, wherein a transmission of a radio packet depends upon an anonymous address when it uses a frequency from a frequency-hopping-sequence based upon the anonymous address.

7. A method as claimed in claim 1, wherein a transmission of a radio packet depends upon an anonymous address when it is a L2CAP link establishment packet.

8. A method as claimed in claim 1, wherein the step of disabling prevents the transmission of FHS packets between the first time and the second time.

9. A method as claimed in claim 1, wherein the step of disabling prevents the mobile transceiver replying to an inquiry request between the first time and the second time.

10. A method as claimed in claim 1, wherein the step of disabling prevents the mobile transceiver replying to a page request between the first time and the second time.

11. A method as claimed in claim 1, further comprising transmitting, between the first time and the second time, radio packets that depend on neither the first anonymous address nor the second anonymous address.

12. A method as claimed in claim 1, wherein the time duration between the first period of time and the second period of time is adjustable.

13. A method as claimed in claim 1, wherein each of a plurality of mobile transceiver has its own local time reference and each of the plurality of mobile transceivers mobile transceivers:
enables, until its first local time, the transmission of a radio packet that depends upon its first anonymous address;
enables, from its second local time, the transmission of a radio packet that depends upon its second anonymous address; and
disables, between its first local time and its second local time, the transmission of a radio packet that depends on either its first anonymous address or its second anonymous address.

14. A method as claimed in claim 13, further comprising randomly generating its second local time.

15. A method as claimed in claim 13, wherein the difference between its first local time and its second local time comprises a calculated minimum period and a randomly generated period.

16. A method as claimed in claim 13, wherein its first local time is adjustable by varying the frequency with which its anonymous address is changed.

17. A method as claimed in claim 16, wherein the frequency with which its anonymous address is changed is automatically adjustable in dependence upon any one or more of: a measure of the separation of the plurality of the mobile transceivers, a measure of the accuracy with which a mobile transceiver can be located and a measure of the speed with which a mobile transceiver moves.

18. A method as claimed in claim 13, wherein the period between its first local time and its second local time is adjustable.

19. A method as claimed in claim 18, wherein the period between its first local time and its second local time is automatically adjustable in dependence upon any one or more of: a measure of the separation of the plurality of the mobile transceivers, a measure of the accuracy with which a mobile transceiver can be located and a measure of the speed with which a mobile transceiver moves.

20. A method as claimed in claim 1, wherein a plurality of mobile transceivers are time synchronized to have a common time reference and each mobile transceiver:
enables, until a first common time, the transmission of a radio packet that depends upon its first anonymous address;
enables, from a second common time, the transmission of a radio packet that depends upon its second anonymous address; and
disables, between the first common time and the second common time, the transmission of a radio packet that depends on either its first anonymous address or its second anonymous address.

21. A method as claimed in claim 20, wherein the time period between the first common time and the second common time is adjustable.

22. A method as claimed in claim 21, wherein the time period between the first common time and the second common time is automatically adjustable in dependence upon any one or more of: a measure of the separation of the plurality of the mobile transceivers, a measure of the accuracy with which a mobile transceiver can be located and a measure of the speed with which a mobile transceiver moves.

23. A method for combating the tracking of a mobile transceiver, comprising at the mobile transceiver:
transmitting, until a first time, radio packets that depend upon a first anonymous address;
transmitting, from a second time, radio packets that depend upon a second anonymous address; and
transmitting, between the first time and the second time, radio packets that depend on neither the first anonymous address nor the second anonymous address.

24. A method for combating the tracking of a plurality of mobile transceivers each of which has its own local time reference, comprising, at each of the plurality of mobile transceivers:
enabling, until a first local time, the transmission of a radio packet that depends upon a locally generated first anonymous address;
enabling, from a second local time, the transmission of a radio packet that depends upon a locally generated second anonymous address; and
disabling, between the first local time and the second local time, the transmission of a radio packet that depends on either its locally generated first anonymous address or its locally generated second anonymous address.

25. A method for combating the tracking of a plurality of mobile transceivers that are time synchronized to a common time reference, comprising, at each of the plurality of mobile transceivers:
enabling, until a first common time, the transmission of a radio packet that depends upon its first anonymous address;
enabling, from a second common time, the transmission of a radio packet that depends upon its second anonymous address; and
disabling, between the first common time and the second common time, the transmission of a radio packet that depends on either its first anonymous address or its second anonymous address.
